(19) United States
(12) Patent Application Publication
(10) Pub. No.: US 2019/0079788 A1
(43) Pub. Date: Mar. 14, 2019

(54) PREDICTIVE IMAGE STORAGE SYSTEM FOR FAST CONTAINER EXECUTION

(71) Applicant: Cisco Technology, Inc., San Jose, CA (US)

(72) Inventors: Guillaume Ruty, Paris (FR); Pierre Pfister, Angers (FR); Jerome Tollet, Paris (FR); William Mark Townsley, Paris (FR); Andre Jean-Marie Surcouf, St. Leu La Foret (FR)

(21) Appl. No.: 15/698,980

(22) Filed: Sep. 8, 2017

(51) Int. Cl. G06F 9/455; G06F 9/445; G06F 9/50; G06F 3/06

(52) U.S. Cl. CPC G06F 9/45558; G06F 8/63; G06F 3/0665; G06F 9/5055; G06F 9/5077

(57) ABSTRACT

Systems, methods, and computer-readable media for controlling container execution. In some examples, a system can determine whether a block of a container image used in running a container is present in local storage at a host. If the block of the container image is present in the local storage at the host, then the system can use the block in the local storage to run the container at the host. If the block of the container image is absent from the local storage at the host, the system can fetch the block of the container image for the host from a container image storage node where the container image resides in its entirety. The system can use the block of the container image fetched from the container image storage node to run the container.

### TECHNICAL FIELD

The present technology pertains to container execution, and in particular to virtualization of container images at hosts to allow for fast container execution.

### BACKGROUND

Currently, the workflow for executing containers includes first downloading the container image in its entirety on a host node and beginning to run the container once the entire container image is downloaded on the host. Container images can include a number of incremental layers that are added to a container image during the life of the container. As container images can include a large number of layers, with an average of 23.3 layers per container, the size of contain images can be large, with an average size of 2.4 GB. While the size of a container image is large, a majority of the data making up the container image is not needed to execute a container using the container image. For example, an average of 242 MB of a container image with an average size of 2.4 GB is actually data used to execute the container. As container images are of a large size and the entire container image is downloaded before beginning execution of a container, a number of problems are introduced. One such problem is the creation of latency between a time a command to execute a container is input and a time when execution of the container actually begins, otherwise referred to as the time to “spin up” a container. Additionally, transferring entire container images to compute nodes reduces local storage space on the compute nodes used to run containers while consuming large amounts of network resources to transfer the entire container images. These problems can be more exacerbated by the fact that container images are frequently modified, e.g. through the addition of more layers, requiring frequent updating of the container images across a plurality of nodes.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture;

FIG. 1B illustrates an example fog computing architecture;

FIGS. 2A and 2B illustrate diagrams of example network environments;

FIG. 3 depicts an example container image virtualization system;

FIG. 4 illustrates a flowchart for an example container image virtualization method;

FIG. 5 depicts an example predictive container image virtualization system;

FIG. 6 illustrates a flowchart for an example method of prefetching blocks of a container image virtualized at a host;

FIG. 7 illustrates an example computing system; and

FIG. 8 illustrates an example network device.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

A method can include determining whether a block of a container image used in running a container is present in local storage at a host. If the block of the container image is present in the local storage at the host, then the block can be retrieved from the local storage and used to run the container at the host. If the block of the container image is absent from the local storage at the host, the block of the container image can be fetched for the host from a container image storage node where the container image resides in its entirety. Once the block is received at the host from the container image storage node as part of fetching the block, then container can be run using the received block of the container image.

A system can determine whether a block of a container image used in running a container is present in local storage at a host. If the block of the container image is present in the local storage at the host, then the system can use the block in the local storage to run the container at the host. If the system determines the block of the container image is absent from the local storage, then the system can fetch the block of the container image for the host from a container image storage node remote from the host where the container image resides in its entirety. The system can use the block of the container image fetched from the container image storage node to run the container.

A system can determine whether a block of a container image virtualized at a host and used in running a container is present in local storage at the host. If the block of the container image is present in the local storage at the host, then the system can use the block in the local storage to run the container at the host. If the system determines the block of the container image is absent from the local storage, the system can subsequently fetch the block of the container image for the host from a container image storage node where the container image resides in its entirety. The system can use the block of the container image fetched from the container image storage node to run the container.

### Description

The disclosed technology addresses the need in the art for mechanisms for fast container execution.

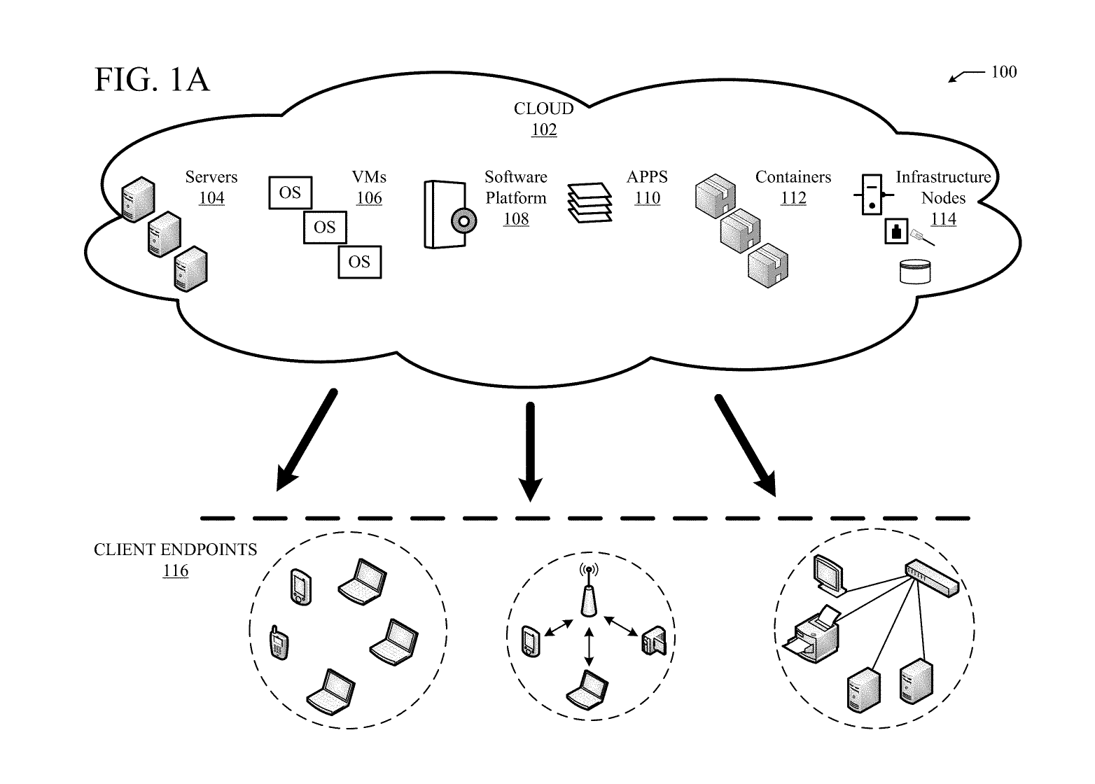

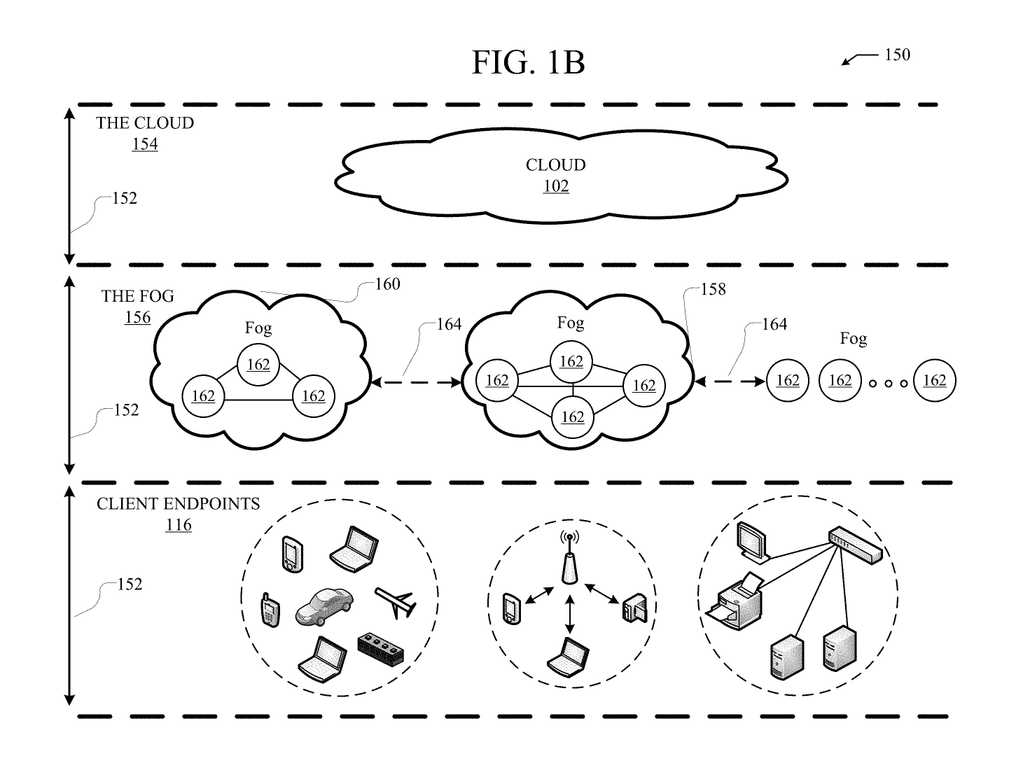

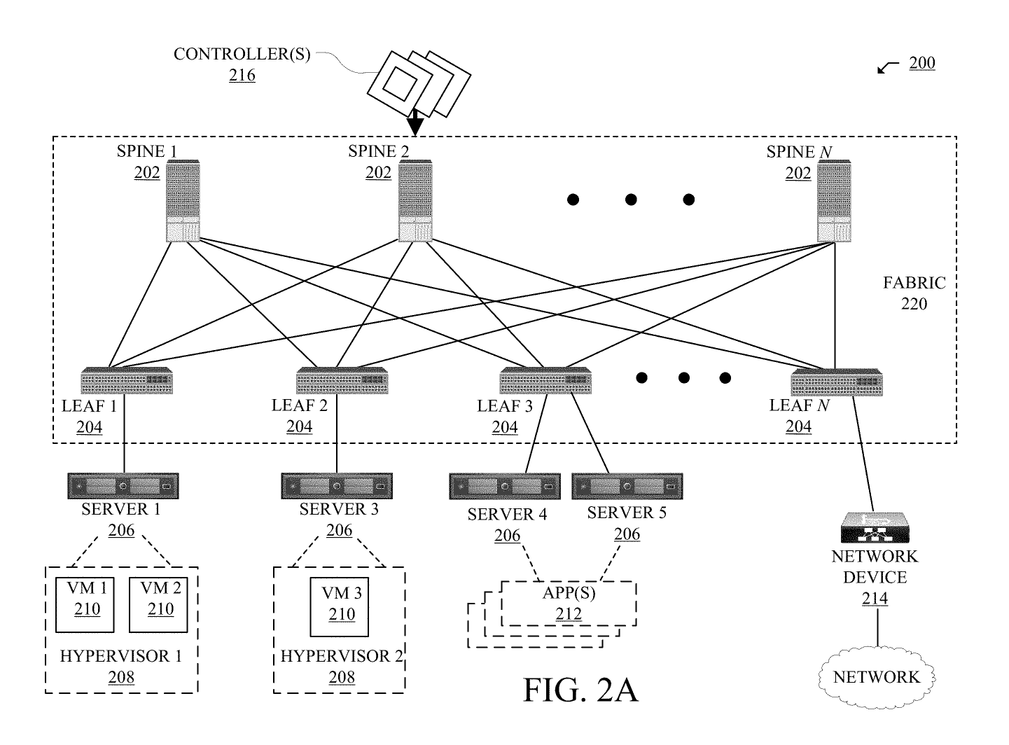

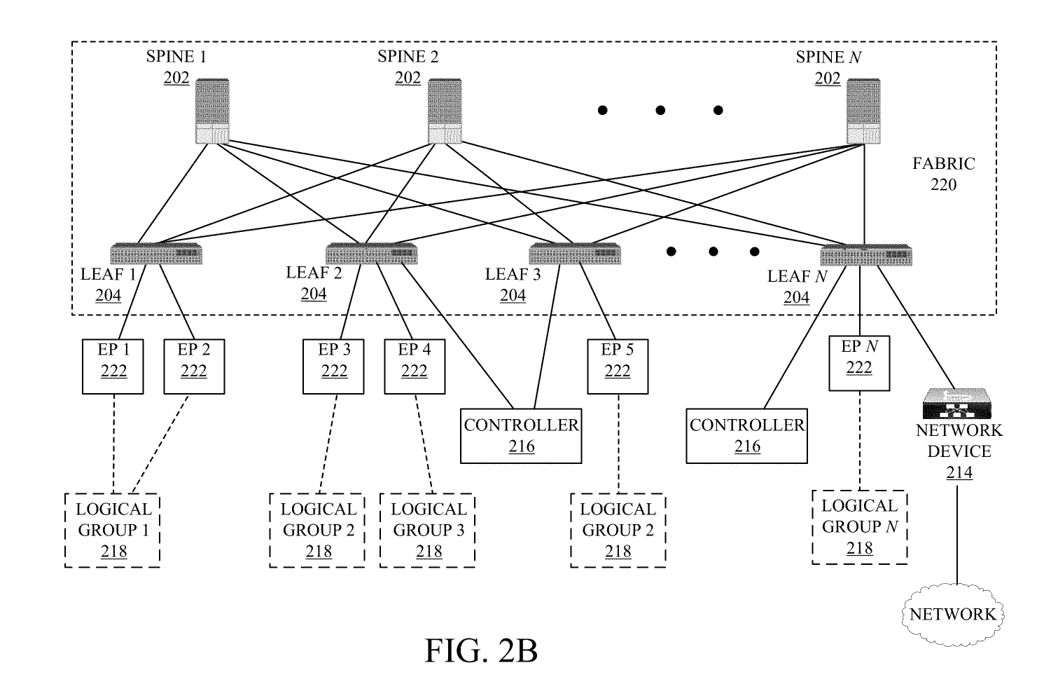

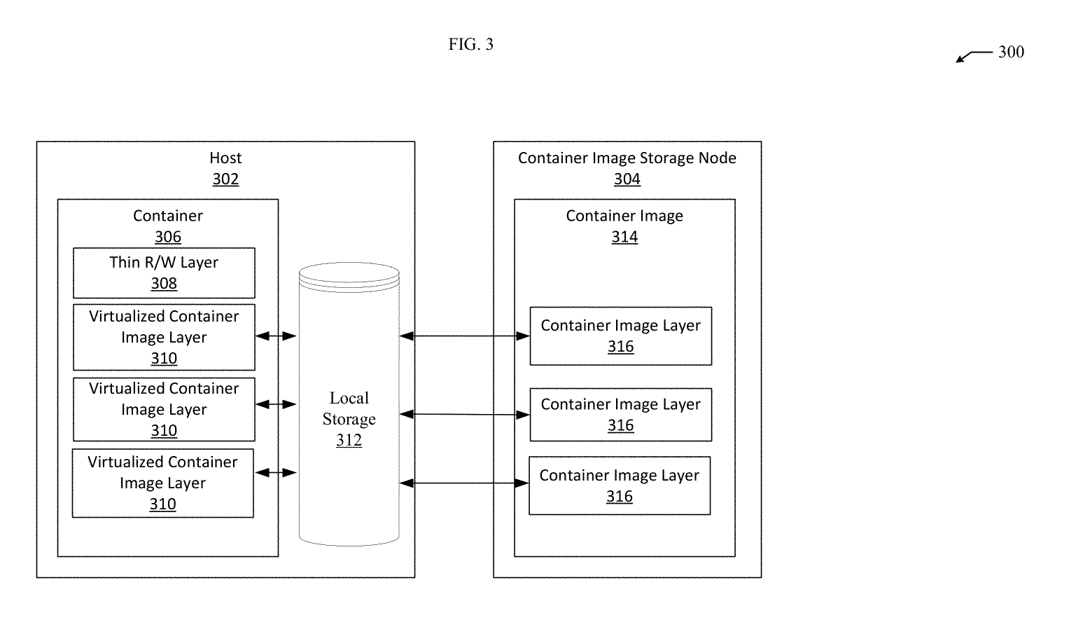

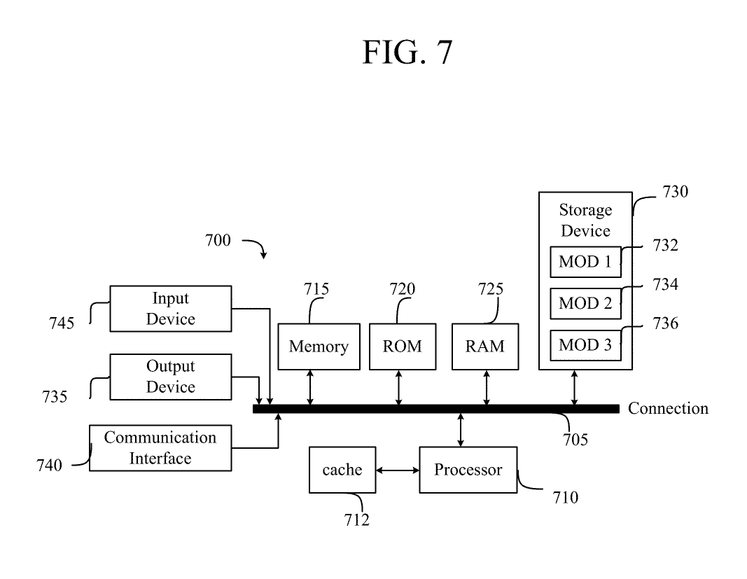

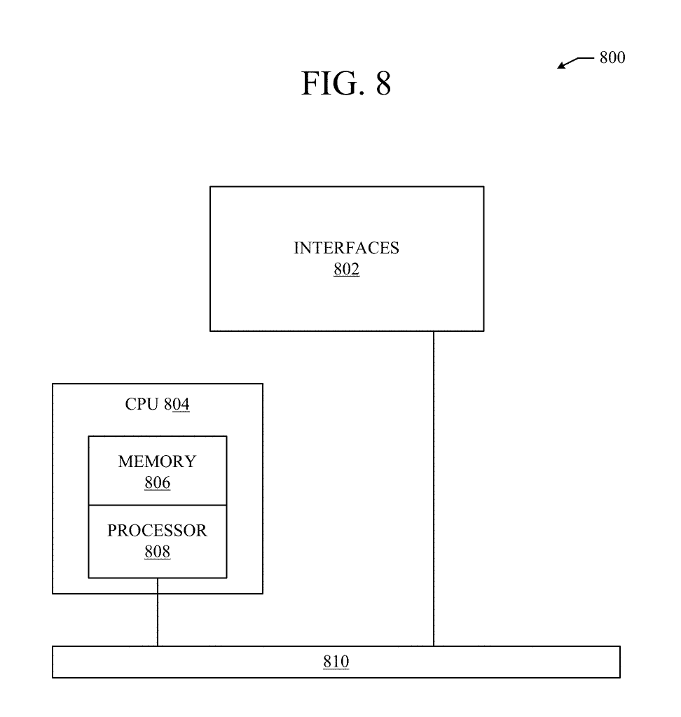

A description of network environments and architectures for network data access and services, as illustrated in FIGS. 1A, 1B, 2A, and 2B, is first disclosed herein. A discussion of systems and methods for virtualizing container images, as shown in FIGS. 3, 4, 5, and 6, will then follow. The discussion then concludes with a brief description of example devices, as illustrated in FIGS. 7 and 8. These variations shall be described herein as the various embodiments are set forth. The disclosure now turns to FIG. 1A.

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 158 can be local or regional clouds or networks. For example, the fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud 154 while located at the starting location and switch to a different physical and/or logical connection point with the cloud 154 while located at the destination location. The particular fog node can thus move within particular clouds and/or fog instances and, therefore, serve endpoints from different locations at different times.

FIG. 2A illustrates a diagram of an example Network Environment 200, such as a data center. In some cases, the Network Environment 200 can include a data center, which can support and/or host the cloud 102. The Network Environment 200 can include a Fabric 220 which can represent the physical layer or infrastructure (e.g., underlay) of the Network Environment 200. Fabric 220 can include Spines 202 (e.g., spine routers or switches) and Leafs 204 (e.g., leaf routers or switches) which can be interconnected for routing or switching traffic in the Fabric 220. Spines 202 can interconnect Leafs 204 in the Fabric 220, and Leafs 204 can connect the Fabric 220 to an overlay or logical portion of the Network Environment 200, which can include application services, servers, virtual machines, containers, endpoints, etc. Thus, network connectivity in the Fabric 220 can flow from Spines 202 to Leafs 204, and vice versa. The interconnections between Leafs 204 and Spines 202 can be redundant (e.g., multiple interconnections) to avoid a failure in routing. In some embodiments, Leafs 204 and Spines 202 can be fully connected, such that any given Leaf is connected to each of the Spines 202, and any given Spine is connected to each of the Leafs 204. Leafs 204 can be, for example, top-of-rack (“ToR”) switches, aggregation switches, gateways, ingress and/or egress switches, provider edge devices, and/or any other type of routing or switching device.

Leafs 204 can be responsible for routing and/or bridging tenant or customer packets and applying network policies or rules. Network policies and rules can be driven by one or more Controllers 216, and/or implemented or enforced by one or more devices, such as Leafs 204. Leafs 204 can connect other elements to the Fabric 220. For example, Leafs 204 can connect Servers 206, Hypervisors 208, Virtual Machines (VMs) 210, Applications 212, Network Device 214, etc., with Fabric 220. Such elements can reside in one or more logical or virtual layers or networks, such as an overlay network. In some cases, Leafs 204 can encapsulate and decapsulate packets to and from such elements (e.g., Servers 206) in order to enable communications throughout Network Environment 200 and Fabric 220. Leafs 204 can also provide any other devices, services, tenants, or workloads with access to Fabric 220. In some cases, Servers 206 connected to Leafs 204 can similarly encapsulate and decapsulate packets to and from Leafs 204. For example, Servers 206 can include one or more virtual switches or routers or tunnel endpoints for tunneling packets between an overlay or logical layer hosted by, or connected to, Servers 206 and an underlay layer represented by Fabric 220 and accessed via Leafs 204.

Applications 212 can include software applications, services, containers, appliances, functions, service chains, etc. For example, Applications 212 can include a firewall, a database, a CDN server, an IDS/IPS, a deep packet inspection service, a message router, a virtual switch, etc. An application from Applications 212 can be distributed, chained, or hosted by multiple endpoints (e.g., Servers 206, VMs 210, etc.), or may run or execute entirely from a single endpoint.

VMs 210 can be virtual machines hosted by Hypervisors 208 or virtual machine managers running on Servers 206. VMs 210 can include workloads running on a guest operating system on a respective server. Hypervisors 208 can provide a layer of software, firmware, and/or hardware that creates, manages, and/or runs the VMs 210. Hypervisors 208 can allow VMs 210 to share hardware resources on Servers 206, and the hardware resources on Servers 206 to appear as multiple, separate hardware platforms. Moreover, Hypervisors 208 on Servers 206 can host one or more VMs 210.

In some cases, VMs 210 and/or Hypervisors 208 can be migrated to other Servers 206. Servers 206 can similarly be migrated to other locations in Network Environment 200. For example, a server connected to a specific leaf can be changed to connect to a different or additional leaf. Such configuration or deployment changes can involve modifications to settings, configurations and policies that are applied to the resources being migrated as well as other network components.

In some cases, one or more Servers 206, Hypervisors 208, and/or VMs 210 can represent or reside in a tenant or customer space. Tenant space can include workloads, services, applications, devices, networks, and/or resources that are associated with one or more clients or subscribers. Accordingly, traffic in Network Environment 200 can be routed based on specific tenant policies, spaces, agreements, configurations, etc. Moreover, addressing can vary between one or more tenants. In some configurations, tenant spaces can be divided into logical segments and/or networks and separated from logical segments and/or networks associated with other tenants. Addressing, policy, security and configuration information between tenants can be managed by Controllers 216, Servers 206, Leafs 204, etc.

Configurations in Network Environment 200 can be implemented at a logical level, a hardware level (e.g., physical), and/or both. For example, configurations can be implemented at a logical and/or hardware level based on endpoint or resource attributes, such as endpoint types and/or application groups or profiles, through a software-defined network (SDN) framework (e.g., Application-Centric Infrastructure (ACI) or VMWARE NSX). To illustrate, one or more administrators can define configurations at a logical level (e.g., application or software level) through Controllers 216, which can implement or propagate such configurations through Network Environment 200. In some examples, Controllers 216 can be Application Policy Infrastructure Controllers (APICs) in an ACI framework. In other examples, Controllers 216 can be one or more management components for associated with other SDN solutions, such as NSX Managers.

Such configurations can define rules, policies, priorities, protocols, attributes, objects, etc., for routing and/or classifying traffic in Network Environment 100. For example, such configurations can define attributes and objects for classifying and processing traffic based on Endpoint Groups (EPGs), Security Groups (SGs), VM types, bridge domains (BDs), virtual routing and forwarding instances (VRFs), tenants, priorities, firewall rules, etc. Other example network objects and configurations are further described below. Traffic policies and rules can be enforced based on tags, attributes, or other characteristics of the traffic, such as protocols associated with the traffic, EPGs associated with the traffic, SGs associated with the traffic, network address information associated with the traffic, etc. Such policies and rules can be enforced by one or more elements in Network Environment 200, such as Leafs 204, Servers 206, Hypervisors 208, Controllers 216, etc. As previously explained, Network Environment 200 can be configured according to one or more particular software-defined network (SDN) solutions, such as CISCO ACI or VMWARE NSX. These example SDN solutions are briefly described below.

ACI can provide an application-centric or policy-based solution through scalable distributed enforcement. ACI supports integration of physical and virtual environments under a declarative configuration model for networks, servers, services, security, requirements, etc. For example, the ACI framework implements EPGs, which can include a collection of endpoints or applications that share common configuration requirements, such as security, QoS, services, etc. Endpoints can be virtual/logical or physical devices, such as VMs, containers, hosts, or physical servers that are connected to Network Environment 200. Endpoints can have one or more attributes such as a VM name, guest OS name, a security tag, application profile, etc. Application configurations can be applied between EPGs, instead of endpoints directly, in the form of contracts. Leafs 204 can classify incoming traffic into different EPGs. The classification can be based on, for example, a network segment identifier such as a VLAN ID, VXLAN Network Identifier (VNID), NVGRE Virtual Subnet Identifier (VSID), MAC address, IP address, etc.

In some cases, classification in the ACI infrastructure can be implemented by Application Virtual Switches (AVS), which can run on a host, such as a server or switch. For example, an AVS can classify traffic based on specified attributes, and tag packets of different attribute EPGs with different identifiers, such as network segment identifiers (e.g., VLAN ID). Finally, Leafs 204 can tie packets with their attribute EPGs based on their identifiers and enforce policies, which can be implemented and/or managed by one or more Controllers 216. Leaf 204 can classify to which EPG the traffic from a host belongs and enforce policies accordingly.

Another example SDN solution is based on VMWARE NSX. With VMWARE NSX, hosts can run a distributed firewall (DFW) which can classify and process traffic. Consider a case where three types of VMs, namely, application, database and web VMs, are put into a single layer-2 network segment. Traffic protection can be provided within the network segment based on the VM type. For example, HTTP traffic can be allowed among web VMs, and disallowed between a web VM and an application or database VM. To classify traffic and implement policies, VMWARE NSX can implement security groups, which can be used to group the specific VMs (e.g., web VMs, application VMs, database VMs). DFW rules can be configured to implement policies for the specific security groups. To illustrate, in the context of the previous example, DFW rules can be configured to block HTTP traffic between web, application, and database security groups.

Returning now to FIG. 2A, Network Environment 200 can deploy different hosts via Leafs 204, Servers 206, Hypervisors 208, VMs 210, Applications 212, and Controllers 216, such as VMWARE ESXi hosts, WINDOWS HYPER-V hosts, bare metal physical hosts, etc. Network Environment 200 may interoperate with a variety of Hypervisors 208, Servers 206 (e.g., physical and/or virtual servers), SDN orchestration platforms, etc. Network Environment 200 may implement a declarative model to allow its integration with application design and holistic network policy.

Controllers 216 can provide centralized access to fabric information, application configuration, resource configuration, application-level configuration modeling for a software-defined network (SDN) infrastructure, integration with management systems or servers, etc. Controllers 216 can form a control plane that interfaces with an application plane via northbound APIs and a data plane via southbound APIs.

As previously noted, Controllers 216 can define and manage application-level model(s) for configurations in Network Environment 200. In some cases, application or device configurations can also be managed and/or defined by other components in the network. For example, a hypervisor or virtual appliance, such as a VM or container, can run a server or management tool to manage software and services in Network Environment 200, including configurations and settings for virtual appliances.

As illustrated above, Network Environment 200 can include one or more different types of SDN solutions, hosts, etc. For the sake of clarity and explanation purposes, various examples in the disclosure will be described with reference to an ACI framework, and Controllers 216 may be interchangeably referenced as controllers, APICs, or APIC controllers. However, it should be noted that the technologies and concepts herein are not limited to ACI solutions and may be implemented in other architectures and scenarios, including other SDN solutions as well as other types of networks which may not deploy an SDN solution.

Further, as referenced herein, the term “hosts” can refer to Servers 206 (e.g., physical or logical), Hypervisors 208, VMs 210, containers (e.g., Applications 212), etc., and can run or include any type of server or application solution. Non-limiting examples of “hosts” can include virtual switches or routers, such as distributed virtual switches (DVS), application virtual switches (AVS), vector packet processing (VPP) switches; VCENTER and NSX MANAGERS; bare metal physical hosts; HYPER-V hosts; VMs; DOCKER Containers; etc.

FIG. 2B illustrates another example of Network Environment 200. In this example, Network Environment 200 includes Endpoints 222 connected to Leafs 204 in Fabric 220. Endpoints 222 can be physical and/or logical or virtual entities, such as servers, clients, VMs, hypervisors, software containers, applications, resources, network devices, workloads, etc. For example, an Endpoint 222 can be an object that represents a physical device (e.g., server, client, switch, etc.), an application (e.g., web application, database application, etc.), a logical or virtual resource (e.g., a virtual switch, a virtual service appliance, a virtualized network function (VNF), a VM, a service chain, etc.), a container running a software resource (e.g., an application, an appliance, a VNF, a service chain, etc.), storage, a workload or workload engine, etc. Endpoints 122 can have an address (e.g., an identity), a location (e.g., host, network segment, virtual routing and forwarding (VRF) instance, domain, etc.), one or more attributes (e.g., name, type, version, patch level, OS name, OS type, etc.), a tag (e.g., security tag), a profile, etc.

Endpoints 222 can be associated with respective Logical Groups 218. Logical Groups 218 can be logical entities containing endpoints (physical and/or logical or virtual) grouped together according to one or more attributes, such as endpoint type (e.g., VM type, workload type, application type, etc.), one or more requirements (e.g., policy requirements, security requirements, QoS requirements, customer requirements, resource requirements, etc.), a resource name (e.g., VM name, application name, etc.), a profile, platform or operating system (OS) characteristics (e.g., OS type or name including guest and/or host OS, etc.), an associated network or tenant, one or more policies, a tag, etc. For example, a logical group can be an object representing a collection of endpoints grouped together. To illustrate, Logical Group 1 can contain client endpoints, Logical Group 2 can contain web server endpoints, Logical Group 3 can contain application server endpoints, Logical Group N can contain database server endpoints, etc. In some examples, Logical Groups 218 are EPGs in an ACI environment and/or other logical groups (e.g., SGs) in another SDN environment.

Traffic to and/or from Endpoints 222 can be classified, processed, managed, etc., based Logical Groups 218. For example, Logical Groups 218 can be used to classify traffic to or from Endpoints 222, apply policies to traffic to or from Endpoints 222, define relationships between Endpoints 222, define roles of Endpoints 222 (e.g., whether an endpoint consumes or provides a service, etc.), apply rules to traffic to or from Endpoints 222, apply filters or access control lists (ACLs) to traffic to or from Endpoints 222, define communication paths for traffic to or from Endpoints 222, enforce requirements associated with Endpoints 222, implement security and other configurations associated with Endpoints 222, etc.

In an ACI environment, Logical Groups 218 can be EPGs used to define contracts in the ACI. Contracts can include rules specifying what and how communications between EPGs take place. For example, a contract can define what provides a service, what consumes a service, and what policy objects are related to that consumption relationship. A contract can include a policy that defines the communication path and all related elements of a communication or relationship between endpoints or EPGs. For example, a Web EPG can provide a service that a Client EPG consumes, and that consumption can be subject to a filter (ACL) and a service graph that includes one or more services, such as firewall inspection services and server load balancing.

### Container Image Virtualization

FIG. 3 depicts an example container image virtualization system 300. The container image virtualization system 300 can be used to virtualize a container image using a host 302 and a container image storage node 304. In virtualizing a container image using the host 302 and the container image storage node 304, the container image virtualization system 300 can be implemented at either or both the host 302 and the container image storage node 304. Additionally, the host 302 and the container images storage node 304 can be implemented remote from each other, thereby potentially creating a distributed container image virtualization system 300. For example, the container image storage node 304 can be implemented at a datacenter within the cloud 102, while the host 302 can be implemented remote from the container image storage node 304 as part of an EPG.

While only a single host 302 and a single container image storage node 304 is shown in the example container image virtualization system 300 in FIG. 3, the container image virtualization system 300 can include a plurality of hosts and container image storage nodes. For example, the container image virtualization system 300 can include a plurality of container image storage nodes serving a plurality of hosts. In another example, the container image virtualization system 300 can include a single container image storage node serving a plurality of hosts, potentially simultaneously.

The container image virtualization system 300 can be implemented at either or both a host 302 and a container image storage node 304. Both the host 302 and the container image storage node 304 can be integrated at a device or devices as described herein, such as a leaf router and an endpoint. Additionally, the container image virtualization system 300 shown in FIG. 3 can be implemented in either or both the fog 156 and/or the cloud 102 by being implemented at devices in either or both the fog 156 and the cloud 102. For example, the container image virtualization system 300 can be implemented at a datacenter implemented in the cloud 102. In another example, the container image virtualization system 300 can be implemented across one or a plurality of fog nodes in the fog 156.

The container image virtualization system 300 can virtualize a container image at the host 302 for purposes of running a container using the contain image virtualized at the host 302. A container image can be virtualized at the host 302 in that the entire container image does not need to be present locally at the host 302, while the container image appears to be present in its entirety at the host 302. Further, as part of virtualizing a container image at the host 302, the container image virtualization system can run a container at the host 302 while the entire container image is not present at the host, e.g. using blocks or portions of the container image that reside locally at the host 302.

Blocks, or otherwise portions, of a container image can include portions of data in a container image that can be used to run a container. Specifically, blocks of a container image can include an entire layer of a plurality of incremental layers of a contain image. For example, a block of a container image can include a first layer of 24 sequential layers of the container image used in beginning execution of a container using the container image. Additionally, blocks of a container image can include portions of a layer of a container image. For example, a block of a container image can include a portion of a layer of the container image used to resume execution of a container using the container image.

Blocks of a container image can include either or both portions of read only layers and read/write layers of a container image. For example, blocks of a container image can include read only layers of a container image that are appended onto the container image sequentially as the container image is modified. In another example, blocks of a container image can include a read/write layer, e.g. a thin read/write layer, included as part of the container image and used in executing a container at a host.

By virtualizing a container image at the host 302, the entire container image does not need to be transferred to the host 302, e.g. as part of a pull (e.g., a pull from a container platform such as DOCKER), in order for the host 302 to execute a container. In particular, as an average of 8%, and rarely exceeding 25%, of data included in a container image is actually executable, downloading the entire container image an ineffective use of resources. In particular, in virtualizing a container image at the host 302, valuable storage resources at the host 302 can be saved. Further, in virtualizing a container image at the host 302, network resources that would be consumed in transferring the entire container image to the host 302 can be saved.

Additionally, by virtualizing a container image at the host 302, a container can be executed at the host 302 without the entire container image residing in local storage at the host 302. For example, a container can be run at the host 302 while only a single or a few container image layers actually reside at the host 302, e.g. 2 out of 23 layers. This can allow for faster container execution at the host 302. For example, portions or blocks of a container image needed to begin execution of a container can be sent to the host 302. Further in the example, the host 302 can subsequently begin running a container using the portions of the container image before receiving, or potentially not receiving, the entire container image. As a result, an amount of time between when a command to execute a container is received and when the container is actually run at the host 302 can be effectively reduced.

The host 302 includes a container 306 running or capable of being run at the host 302, e.g. an instance of the container 306. The container 306 can be supported by or otherwise executed using an overlay file system. The overlay file system includes a thin read/write layer. The thin read/write layer is a writable layer that can be used to read and write data as part of executing the container 306. More specifically, modifications made to the container 306 through execution of the container 306 at the host 302 can be made in the thin read/write layer 308.

The overlay file system also includes one or a plurality of virtualized container image layers 310. The virtualized container image layers 310 can include all or portions of the container image layers 310 residing locally at the host 302. Additionally, the virtualized container image layers 310 can include all or portions of the virtualized container image layers 310 that fail to reside locally at the host 302. While the overlay file system of the container 306 is shown to include three virtualized container image layers 310, in various embodiments, the overlay file system can include one virtualized container image layer or an applicable plurality of virtualized container image layers.

The virtualized container image layers 310 can be used by the thin read/write layer 308 to execute the container 306 at the host 302. Specifically, the thin read/write layer 308 can use the virtualized container image layers 310 to begin or continue execution of the container 306 at the host 302.

The local storage 312 can function to store data locally at the host 302. For example, the local storage 312 can include cache at the host 302. The local storage 312 can store data used in executing the container 306 at the host 302 using the virtualized container image layers 310. In particular the local storage 312 can store all or portions of the virtualized container image layers 310 at the host 302 for purposes of executing the container 306 at the host. For example, the local storage 312 can store all of a first container image layer and a portion of a second container image layer of the virtualized container image layers 310 at the host 302, for use in executing the container 306 at the host 302.

The container image storage node 304 includes a container image 314. The container image 314 can reside in its entirety at the container image storage node 304 and can include container image layers 316 forming the entire container image 314. Additionally, the container image 314 stored at the container image storage node 304 can correspond to the container 306 executed, or capable of being executed, at the host 302 using the virtualized container image layers 310. More specifically, the container image layers 316 stored at the container image storage node 304 can correspond to the virtualized container image layers 310 and subsequently be used to virtualize the corresponding virtualized container image layers 310 in the overlay file system executing the container 306 at the host 302.

The container image layers 316 can be broken up into blocks or portions at the container image storage node 304. As a result, portions, otherwise referred to as blocks, of the container image layers 316 can be transmitted from the container image storage node 304 to the host 302, e.g. on a per-portion basis. More specifically, the container image virtualization system 300 can control transfer of portions of the container image layers 316 without transferring each of the entire container image layers 316 to the host 302. This can conserve resources used in transmitting data between the container image storage node 304 and the host 302 and storage resources utilized to store the data transmitted by the container image storage node 304.

The container image virtualization system 300 can control execution of the container 306 at the host 302 using the virtualized container image layers 310. Specifically, the container image virtualization system 300 can control beginning execution of the container 306 at the host 302 using the virtualized container image layers 310. Additionally, the container image virtualization system 300 can control continued execution of the container 306 at the host 302 using the virtualized container image layers 310.

In controlling execution of the container 306, the container image virtualization system 300 can receive commands to execute the container 306 in a particular manner at the host 302. For example, the container image virtualization system 300 can receive a command to begin executing the container 306 at the host 302 or to continue executing the container 306 at the host 302 in a specific manner. Commands for controlling execution of the container 306 at the host 302 can be received by the container image virtualization system 300 from a user.

As part of controlling execution of the container 306, the container image virtualization system 300 can identify a portion or block of the virtualized container image layers 310 to use in executing the container 306 at the host 302. The container image virtualization system 300 can identify a portion of the virtualized container image layers 310 to use in executing the container 306 based on received commands. For example, if a command indicates that a user wants to execute the container 306 in a particular manner at the host 302, then the container image virtualization system 300 can identify a portion of the virtualized container image layers 310 needed to continue execution of the container 306 in the particular manner.

The container image virtualization system 300 can check to see whether an identified portion of the virtualized container image layers 310, e.g. identified based on received commands, resides locally at the host 302. In particular, the container image virtualization system 300 can check in the local storage 312 to determine whether an identified portion of the virtualized container image layers 310 resides locally at the host 302. For example, the container image virtualization system 300 can check the local storage 312 to identify whether a portion of the virtualized container image layers 310 used to begin execution of the container 306 actually resides at the host 302.

If the container image virtualization system 300 determines a portion of the virtualized container image layers 310 does reside locally at the host 302, then the container image virtualization system 300 can use the locally stored portion of the virtualized container image layers 310 to control execution of the container 306. Specifically, the container image virtualization system 300 can retrieve a locally stored portion of the virtualized container image layers 310 and provide it to the overlay file system, where it can be used to begin or continue execution of the container 306 at the host 302.

If the container image virtualization system 300 determines a portion of the virtualized container image layers 310 fails to reside locally at the host 302, then the container image virtualization system 300 can fetch the portion of the virtualized container image layers 310. More specifically, the container image virtualization system 300 can fetch the portion of the virtualized container image layers 310 from a node where the portion resides, e.g. the container image storage node 304. In various embodiments, the container image virtualization system 300 can fetch portions of the virtualized container image layers 310 from either or both a node remote from the host 302 and a node where the container image 314 resides in its entirety, e.g. the container image storage node 304.

In fetching a portion of the virtualized container image layers 310, the container image virtualization system 300 can send a request for the portion of the virtualized container image layers 310. More specifically, the container image virtualization system 300 can send a request for the portion of the virtualized container image layers 310 to a node or a controller of a node where the portion resides, e.g. in the container image layers 316 of the container image 314 stored at the container image storage node 304. In response to a request for the portion of the virtualized container image layers 310, the container image virtualization system 300 can retrieve the portion of the virtualized container image layers 310 from the container image layers 316 of the container image 314 stored at the container image storage node 304. The container image virtualization system 300 can then provide the retrieved portion of the virtualized container image layers 310 to the host 302, where it can be used to execute the container 306 at the host 302.

A portion of the container image layers 316 sent to the host 302 can be used to execute the container 306 at the host 302, and potentially be stored at the host 302, while the container image layers 316 remain virtualized at the host 302. Specifically, the container 306 can be executed at the host 302 while portions of the virtualized container image layers 310 still remain absent from the local storage 312. As a result, the container 306 can be executed at the host 302 before the entire container image 314 is transferred to the local storage 312. This reduces latency between a time when a command to execute the container 306 is received and a time when the container 306 is actually executed at the host 302, thereby corresponding to faster execution of the container 306 at the host 302.

The container image virtualization system 300 can control either or both the gathering and updating of the container image 314, and the corresponding container image layers 316, stored at the container image storage node 304. More specifically, the container image virtualization system 300 can use an applicable data gathering function to gather and update the container image 314 and the corresponding container image layers 316. For example, the container image virtualization system 300 can use a docker pull function to gather an updated container image.

The container image virtualization system 300 can control gathering and updating of container images at the container image storage node 304, as the container image storage node 304 serves a plurality of hosts. As a result, the container images only need to be gathered and updated at the container image storage node 304, and not at the plurality of hosts. This can reduce resource usage in transferring and storing data included as part of container images. Additionally, in only gathering container images for the container image storage node 304 and not for a plurality of hosts, containers can be deployed more easily, as they do not need to be deployed to every host.

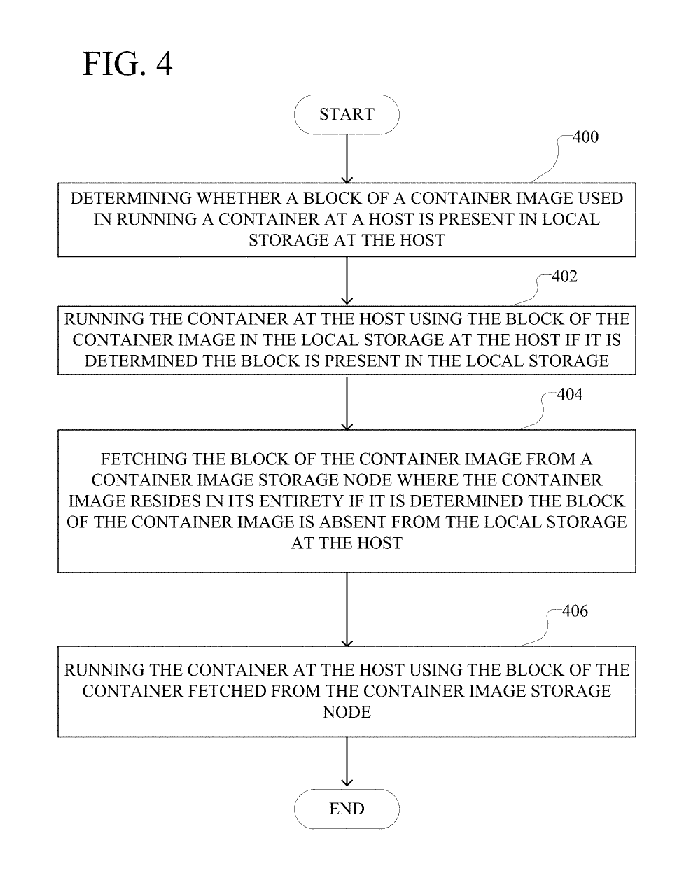

FIG. 4 illustrates a flowchart for an example container image virtualization method. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated.

Each module shown in FIG. 4 represents one or more steps, processes, methods or routines in the method. For the sake of clarity and explanation purposes, the modules in FIG. 4 are described with reference to the container image virtualization system 300 shown in FIG. 3.

At step 400, the container image virtualization system 300 determines whether a block of a container image used in running the container 306 at the host 302 is present in the local storage 312 at the host 302. The block of the container image can correspond to the virtualized container image layers 310 of the container 306 at the host 302. The virtualized container image layers 310 can be virtualized at the host 302 in that the virtualized container image layers 310 do not entirely reside in the local storage 312 at the host 302.

The block of the container image can be a block of the container image identified from a plurality of blocks of the container image. Specifically, a block of the container image can be a portion of the container image needed to begin or continue execution of the container 306 at the host 302. The block of the container image can be identified based on received commands indicating either or both to begin executing the container 306 and manners in which to execute the container 306.

At step 402, the container image virtualization system 300 controls running of the container 306 at the host 302 using the block of the container image in the local storage 312, if it is determined the block of the container image is stored in the local storage 312. In using the locally stored block of the container image, the container image virtualization system 300 can retrieve the block of the container image from the local storage 312 and provide the block to an overlay file system used to execute the container 306. The overlay file system can subsequently use the block of the container image retrieved from the local storage 312 to either or both begin and continue running the container 306 at the host 302.

At step 404, the container image virtualization system 300 fetches the block of the container image from the container image storage node 304, if it is determined that the block of the container image is absent from the local storage 312. The container image 314 can entirely reside at the container image storage node 304. In fetching the block of the container image, the container image virtualization system 300 can send a request for the block of the container image to the container image storage node 304. Further, in fetching the block of the container image, the container image virtualization system 300 can receive, at the host 302, the block of the container image, e.g. in response to a request for the block of the container image. Additionally, as will be discussed in greater detail later, the host 302 can also receive predicted container image blocks along with the block of the container image, for use in executing the container 306 at the host 302.

At step 406, the container image virtualization system 300 controls running of the container 306 at the host 302, using the block of the container image received from the container image storage node 304. Specifically, the container image virtualization system 300 can provide the block of the container image to the overlay file system used to execute the container 306 at the host 302, after the block is received from the container image storage node 304. In certain embodiments, the container image virtualization system 300 can store the block, after it is received from the container image storage node 304, in the local storage 312 at the host 302. This allows for quick retrieval of the block from the local storage 312 at the host 302 in the same instance or potentially different instances of the container 306 at the host.

### Predictive Container Image Virtualization

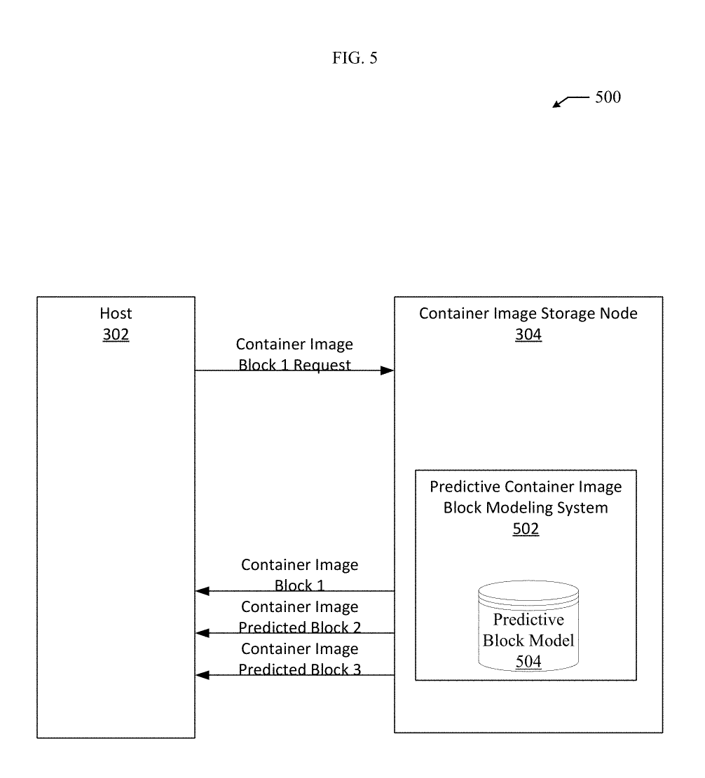

FIG. 5 depicts an example predictive container image virtualization system 500. The predictive container image virtualization system 500 can be used to predictively virtualize a container image at the host 302 using a container image storage node 304. The predictive container image virtualization system 500 can be implemented at either or both the host 302 and the container image storage node 304. For example, a first portion of the predictive container image virtualization system 500 can be implemented at the host 302 and a second portion of the predictive container image virtualization system 500 can be implemented remote from the first portion, at the container image storage node 304. The predictive container image virtualization system 500 can be implemented as part of a system for virtualizing a container image at a host, such as the container image virtualization system 300.

In predictively virtualizing a container image at the host 302, the predictive container image virtualization system 500 can predict portions of a virtualized container image to send to the host 302. The predictive container image virtualization system 500 can then send predicted portions of the virtualized container images to the host 302, as part of predictively virtualizing container images at the host 302. Additionally, as part of predictively virtualizing container images at the host 302, the predictive container image virtualization system 500 can predict portions of container image to send to the host 302 without receiving requests for the predicted portions of the container image. Subsequently, the predictive container image virtualization system 500 can send the predicted portions of the container image to the host 302 without receiving requests for the portions of the container image, e.g. as part of the container image virtualization system 500 prefetching the predicted portions for the host 302.

The predictive container image virtualization system 500 can predict portions of a container image to send to the host 302 based on received requests for portions of a container image virtualized at the host 302. For example, the predictive container image virtualization system 500 can receive, at the container image storage node 304, a request for a first portion of a first layer of a container image virtualized at the host 302. The predictive container image virtualization system 500 can then predict the host 302 will request a second portion of the first layer based on receipt of the request for the first portion of the first layer. The predictive container image virtualization system 500 can subsequently send both the second and first portions of the first layer, from the container image storage node 304 to the host 302, in response to receiving the request for only the first potion of the layer.

The predictive container image virtualization system 500 shown in FIG. 5 specifically illustrates prefetching predicted portions. In the predictive container image virtualization system 500 shown in FIG. 5, the host 302 can send a request for a block 1 of a container image virtualized at the host 302, to the container image storage node 304. Using the request for block 1, the container image storage node 304 can identify blocks 2 and 3 of the container image as predicted blocks, e.g. that the host will request blocks 2 or 3 of the container image. Subsequently, the container image storage node 304 can send container image blocks 2 and 3 along with container image block 1, to the host 302, in response to receiving the request for block 1 from the host. Either or both blocks 2 and 3 can be blocks used in continuing execution of a container at the host 302, after block 1 is used in executing the container at the host 302.

The example predictive container image virtualization system 500 includes a predictive container image block modeling system 502. The predictive container image block modeling system 502 can maintain one or a plurality of predictive block models, indicated by data stored in the predictive block model storage 504. The predictive container image virtualization system 500 can use predictive block models, maintained by the predictive container image block modeling system 502, to identify predicted blocks of container images. The predictive container image virtualization system 500 can subsequently send the predicted blocks to the host 302, e.g. as part of prefetching the predicted blocks. In FIG. 5, the container image predictive block modeling system 502 and the predictive block model 504 are shown at the container image storage node 304 for simplicity purposes, however, in certain embodiments they can be implemented at different nodes, hosts, or locations separate or remote from the container image storage node 304.

While the predictive container image block modelling system 502 is shown implemented at the container image storage node 304 in FIG. 5, in various embodiments the predictive container image block modelling system 502 can be implemented at the host 302. In being implemented at the host 302, the predictive container image block modelling system 502 can determine, at the host 302, predicted blocks to prefetch. Subsequently, the host 302 can request and receive the predicted blocks from the container image storage node 304 based on an identification of the predicted blocks at the host 302.

A predictive block model can included probabilities that specific portions or blocks of a container image will be requested and/or used in executing a container after a first portion of the container image is requested and/or used in executing the container. For example, a predictive block model can include a probability that a second portion of a container image will be read after a first portion of the container image is read. The predictive block model can be represented as an applicable statistical graph or matrix, e.g. an oriented graph and its associated Markov Matrix, illustrating dependencies between portions of a container image, e.g. portions of a layer of the container image. For example, the predictive block model can be represented as a Markov Matrix of the probabilities portions of a container image layer will be requested after a specific portion of the container image layer is requested.

The predictive container image block modeling system 502 can maintain a predictive block model based on past execution of a container, e.g. at the host 302. More specifically, the predictive container image block modeling system 502 can maintain a predictive block model based on portions of container images either or both requested and read during past execution of containers. Further, the predictive container image block modeling system 502 can maintain a predictive block model based on patterns of requested and read portions of container images. For example, the predictive container image block modeling system 502 can identify that in nine out of ten instances of a container, a second portion of a layer of a container image was read or requested after a first portion of the layer was read or requested. Subsequently, the predictive container image block modeling system 502 can update a predictive block model to indicate there is a 90% chance the second portion will be requested or read after the first portion is requested or read.

The predictive container image block modeling system 502 can maintain a predictive block model based on past instances of a container executed using either or both virtualized container images and non-virtualized container images. For example, the predictive container image block modeling system 502 can maintain a predictive block model based on past instance of a container executed at a host or a node where a container image resides completely, e.g. is a non-virtualized container image.

Additionally, the predictive container image block modeling system 502 can use applicable methods of analysis for recognizing requested and read portions and patterns of requested and read portions of container images. For example, the predictive container image block modeling system 502 can analyze binaries and a file used to execute a container (e.g., a dockerfile), in order to identify either or both requested and read portions of a container image and patterns of requested and read portions of the container image.

A predictive block model maintained by the predictive container image block modeling system 502 can be specific to one or a combination of a user, a host, a group associated with a user, a container, a container image, a layer of a container image, and a portion of a container image. For example, a predictive block model can indicate how blocks within a specific layer of a container image are requested and/or read. In another example, a predictive block model can indicate how users within a specific organization request portions of a container image associated with a container.

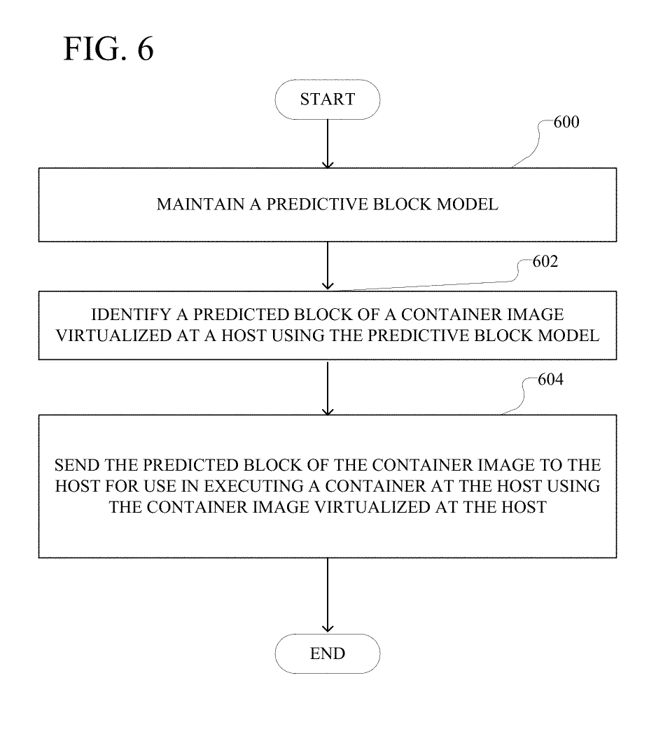

FIG. 6 illustrates a flowchart for an example method of prefetching blocks of a container image virtualized at a host. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated.

Each module shown in FIG. 6 represents one or more steps, processes, methods or routines in the method. For the sake of clarity and explanation purposes, the modules in FIG. 6 are described with reference to the predictive container image virtualization system 500 shown in FIG. 5.

At step 600, the predictive container image block modeling system 502 maintains a predictive block model. A predictive block model can be maintained based on either or both requested and read blocks during past executions of a container using a container image. Additionally, a predictive block model can be maintained based on requested and read blocks during execution of a container using either or both a virtualized or non-virtualized container image.

At step 602, the predictive container image virtualization system 500 identifies a predicted block of a container image virtualized at the host 302, using the predictive block model. A predicted block of a container image can be identified using the predictive block model and a received request for a portion of a container image virtualized at the host 302. For example, if a first portion of a layer of a container image is requested, and the predictive block model indicates a 100% chance that a second portion of the layer will be requested after the first portion, then the second portion of the layer can be selected as a predicted block.

At step 604, the predictive container image virtualization system 500 provides the predicted block of the container image to the host for use in executing the container at the host using the container image virtualized at the host 302. The predicted block can be sent to the host 302 even though the block was not specifically requested by the host 302. Additionally, the predicted block of the container image can be sent to the host 302 as part of prefetching the predicted block. As a result of prefetching the predicted block, a container can be executed with reduced execution latency, as impacts of network latency in transferring blocks of the container image are reduced or removed completely.

The disclosure now turns to FIGS. 7 and 8, which illustrate example network devices and computing devices, such as switches, routers, load balancers, client devices, and so forth.

FIG. 7 illustrates a computing system architecture 700 wherein the components of the system are in electrical communication with each other using a connection 705, such as a bus. Exemplary system 700 includes a processing unit (CPU or processor) 710 and a system connection 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

FIG. 8 illustrates an example network device 800 suitable for performing switching, routing, load balancing, and other networking operations. Network device 800 includes a central processing unit (CPU) 804, interfaces 802, and a bus 810 (e.g., a PCI bus). When acting under the control of appropriate software or firmware, the CPU 804 is responsible for executing packet management, error detection, and/or routing functions. The CPU 804 preferably accomplishes all these functions under the control of software including an operating system and any appropriate applications software. CPU 804 may include one or more processors 808, such as a processor from the INTEL X86 family of microprocessors. In some cases, processor 808 can be specially designed hardware for controlling the operations of network device 800. In some cases, a memory 806 (e.g., non-volatile RAM, ROM, etc.) also forms part of CPU 804. However, there are many different ways in which memory could be coupled to the system.

The interfaces 802 are typically provided as modular interface cards (sometimes referred to as “line cards”). Generally, they control the sending and receiving of data packets over the network and sometimes support other peripherals used with the network device 800. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 804 to efficiently perform routing computations, network diagnostics, security functions, etc.

Although the system shown in FIG. 8 is one specific network device of the present invention, it is by no means the only network device architecture on which the present invention can be implemented. For example, an architecture having a single processor that handles communications as well as routing computations, etc., is often used. Further, other types of interfaces and media could also be used with the network device 800.

Regardless of the network device's configuration, it may employ one or more memories or memory modules (including memory 806) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 806 could also hold various software containers and virtualized execution environments and data.

The network device 800 can also include an application-specific integrated circuit (ASIC), which can be configured to perform routing and/or switching operations. The ASIC can communicate with other components in the network device 800 via the bus 810, to exchange data and signals and coordinate various types of operations by the network device 800, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A method comprising:
determining whether a block of a container image used in running a container corresponding to the container image is present in local storage at a host, the container image residing in a container image storage node;
if it is determined the block of the container image is present in the local storage at the host, running the container using the block of the container image present in the local storage;
if it is determined the block of the container image is absent from the local storage at the host:
fetching the block of the container image from the container image storage node; and
running the container using the block of the container image fetched from the container image storage node.

2. The method of claim 1, further comprising:
sending a request for the block of the container image from the host to the container image storage node as part of fetching the block of the container image from the container image storage node; and
prefetching at least one predicted block of the container image by receiving, at the host from the container image storage node, the at least one predicted block of the container image along with the block of the container image in response to the request for the block of the container image.

3. The method of claim 2, wherein the at least one predicted block includes at least one block of the container image used to continue running the container after the block of the container image is used to run the container at the host.

4. The method of claim 1, wherein the container image storage node is remote from the host.

5. The method of claim 1, further comprising:
determining whether at least one additional block of the container image used to continue running the container after the block of the container image is used to run the container at the host is present in the local storage at the host;
if it is determined that the at least one additional block of the container image used to continue running the container at the host is absent from the local storage at the host:
fetching the at least one additional block of the container image from the container image storage node; and
continue running the container at the host using the at least one additional block of the container image fetched from the container image storage node after the block of the container image is used to run the container at the host.

6. The method of claim 5, further comprising:
receiving a request for the block of the container image at the container image storage node from the host as part of the host fetching the block of the container image from the container image storage node;
receiving a request for the at least one additional block of the container image at the container image storage node from the host as part of the host fetching the at least one additional block of the container image from the container image storage node; and
maintaining a predictive block model for providing blocks of the container image to a plurality of hosts including the host, the predictive block model maintained based on receipt of the request for the block of the container image and receipt of the request for the at least one additional block of the container image at the container image storage node from the host and used to send the at least one additional block of the container image to the plurality of hosts as part of predictively prefetching the at least one additional block of the container image at the hosts.

7. The method of claim 6, wherein the predictive block model is maintained based on receipt of the request for the at least one additional block of the container image after receipt of the request for the block of the container image from the host.

8. The method of claim 1, wherein the block of the container image includes at least a portion of a layer of a plurality of incremental layers of the container image.

9. The method of claim 1, wherein the container image is virtualized at the host.

10. The method of claim 1, further comprising updating the container image at the container image storage node while refraining from updating the container image at the host.

11. The method of claim 1, wherein the block of the container image is used to begin running the container at the host.

12. The method of claim 1, further comprising:
maintaining a predictive block model for the container image based on requests for blocks of the container image used in running the container across a plurality of hosts served by the container image storage node; and
providing at least one predicted block of the container image from the container image storage node to the host using the predictive block model as part of the host prefetching the at least one predicted block of the container image.

13. The method of claim 12, wherein the predictive block model includes probabilities that specific blocks of the container image will be read after a first specific block of the container image is read during running of the container at the plurality of hosts.

14. The method of claim 12, wherein the predictive block model is specific to a single layer of the container image.

15. A system comprising:
one or more processors; and
at least one computer-readable storage medium having stored therein instructions which, when executed by the one or more processors, cause the one or more processors to perform operations comprising:
determining whether a block of a container image used in running a container corresponding to the container image is present in local storage at a host, the container image residing in its entirety at a container image storage node remote from the host;
if it is determined the block of the container image is present in the local storage at the host, running the container using the block of the container image present in the local storage;
if it is determined the block of the container image is absent from the local storage at the host:
fetching the block of the container image from the container image storage node; and
running the container using the block of the container image fetched from the container image storage node.

16. The system of claim 15, the at least one computer-readable storage medium having stored therein additional instructions which, when executed by the one or more processors, cause the one or more processors to perform operations comprising:
sending a request for the block of the container image from the host to the container image storage node as part of fetching the block of the container image from the container image storage node; and
prefetching at least one predicted block of the container image by receiving, at the host from the container image storage node, the at least one predicted block of the container image along with the block of the container image in response to the request for the block of the container image.

17. The system of claim 15, the at least one computer-readable storage medium having stored therein additional instructions which, when executed by the one or more processors, cause the one or more processors to perform operations comprising:
determining whether at least one additional block of the container image used to continue running the container after the block of the container image is used to run the container at the host is present in the local storage at the host;
if it is determined that the at least one additional block of the container image used to continue running the container at the host is absent from the local storage at the host:
fetching the at least one additional block of the container image from the container image storage node; and
continue running the container at the host using the at least one additional block of the container image fetched from the container image storage node after the block of the container image is used to run the container at the host.

18. The system of claim 15, the at least one computer-readable storage medium having stored therein additional instructions which, when executed by the one or more processors, cause the one or more processors to perform operations comprising:
maintaining a predictive block model for the container image based on requests for blocks of the container image used in running the container across a plurality of hosts served by the container image storage node; and
providing at least one predicted block of the container image from the container image storage node to the host using the predictive block model as part of the host prefetching the at least one predicted block of the container image.

19. The system of claim 18, wherein the predictive block model includes probabilities that specific blocks of the container image will be read after a first specific block of the container image is read during running of the container at the plurality of hosts.

20. A non-transitory computer-readable storage medium having stored therein instructions which, when executed by a processor, cause the processor to perform operations comprising:
determining whether a block of a container image used in running a container corresponding to the container image is present in local storage at a host, the container image virtualized at the host and residing in its entirety at a container image storage node;
if it is determined the block of the container image is present in the local storage at the host, running the container using the block of the container image present in the local storage;
if it is determined the block of the container image is absent from the local storage at the host:
fetching the block of the container image from the container image storage node; and
running the container using the block of the container image fetched from the container image storage node.
